(19) United States
(12) Patent Application Publication
(10) Pub. No.: US 2008/0163293 A1
(43) Pub. Date: Jul. 3, 2008

(54) SYSTEM AND METHOD FOR CONTROLLING TRANSMISSION AND DISPLAY OF VIDEO

(75) Inventors: Alex Krummheller, Campbell (AU); Mike Hogan, Campbell (AU); Keith Bengston, Campbell (AU); Alija Kajan, Campbell (AU); Dean Economou, Campbell (AU); Terence Michael Percival, Sydney (AU)

Correspondence Address: MORGAN LEWIS & BOCKIUS LLP, 1111 PENNSYLVANIA AVENUE NW, WASHINGTON, DC, 20004, US

(73) Assignee: Promim Pty Ltd., Murrarie (AU)

(21) Appl. No.: 11/964,592

(22) Filed: Dec. 26, 2007

(30) Foreign Application Priority Data
Jun. 30, 2005 (AU) PCT/AU2005/000948

(51) Int. Cl. H04N 5/445

(52) U.S. Cl. 725/38

(57) ABSTRACT

A system for controlling transmission and display of video signals derived from video sources including receiving means for receiving two or more video signals each derived from video sources; a graphical user interface; selection means allowing a user to select one of the video signals on the graphical user interface; when a user selects a video signal the system is arranged to operate to cause transmission of a second video signal corresponding to the selected video signal.

### TECHNICAL FIELD

This invention relates to a system and method for controlling transmission and display of video.

### BACKGROUND TO THE INVENTION

In video transmission and display systems, such as a video conferencing system, video signals are transmitted from one location to be displayed at another location where the locations are remote from one another.

### SUMMARY OF THE INVENTION

In a first aspect the present invention provides a system for controlling transmission and display of video signals derived from video sources including: receiving means for receiving two or more first video signals each derived from video sources; a graphical user interface; selection means allowing a user to select one of the first video signals on the graphical user interface; when a user selects a first video signal the system is arranged to operate to cause transmission of a second video signal corresponding to the selected first video signal.

The system may be arranged to transmit the second video signal at a higher data rate than the selected first video signal. By sending at a higher data rate only when selected, rather than transmitting continuously at the higher data rate, the volume of data trotted is reduced.

The system may be arranged to transmit the second video signal at a higher resolution or frame rate than the selected first video signal.

The system may be arranged to cease transmission of another video signal upon transmission of the second video signal.

The system may be arranged to cease transmission of video signals to keep bandwidth usage below the available bandwidth.

The user interface may allow a user to select a display destination for the second video signal.

The display destination may be selected by dragging an item on the interface to a particular area of the interface.

The system may be arranged to display the second video signal in a screen area of the graphical user interface.

The system may be arranged to display the second video signal on a monitor separate from the graphical use interface.

In a second aspect the present invention provides a method of controlling transmission and display of video signals derived from video so including the steps of: receiving one or more first video signals each derived from video sources; selecting one of the first video signals by way of a graphical user interface; causing transmission of a second video signal corresponding to the selected first video signal.

The second video signal may be transmitted at a higher data rate than the selected first video signal.

The second video signal may be transmitted at a higher resolution or frame rate than the selected first video signal.

Transmission of another video signal may be ceased upon transmission of the second video signal.

Transmission of video signals may be ceased to keep bandwidth usage below the available bandwidth.

The user interface may allow a user to select a display destination for the second video signal.

The display destination may be selected by dragging an item on the interface to a particular area of the interface.

The second video signal may be displayed in a screen area of the graphical user interface.

The second video signal may be displayed on a monitor separate from the graphical user interface.

The first and second video signals may be transmitted from a remote location.

### BRIEF DESCRIPTION OF THE DRAWINGS

Embodiments of the present invention will now be described, by way of example only, with reference to the accompanying drawings, in which:

FIG. 1 is a schematic diagram illustrating hardware used in a system according to an embodiment of the invention; and

FIG. 2 is a schematic diagram illustrating hardware used at a location remote from the system of FIG. 1 and which transmits video signals under the control of the system of FIG. 1;

FIG. 3 is a schematic illustration of software running on the hardware illustrated in both FIGS. 1 and 2; and

FIG. 4 illustrates a graphical user interface displayed by the system of FIG. 1;

FIG. 5 illustrates an alternative user interface that can be displayed by the system of FIG. 1;

FIG. 6 illustrates a graphical user interface displayed in an alternative embodiment of the system; and

FIG. 7 is a schematic illustration of software running on the system of FIG. 6.

### DETAILED DESCRIPTION OF THE PREFERRED EMBODIMENT

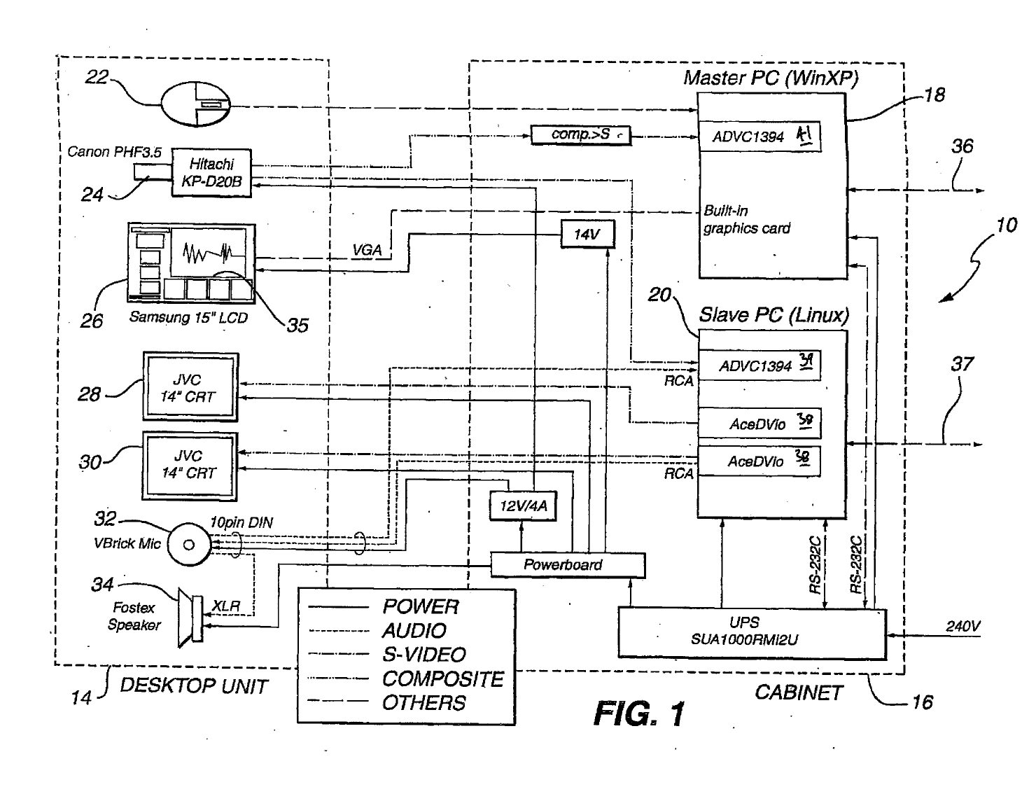

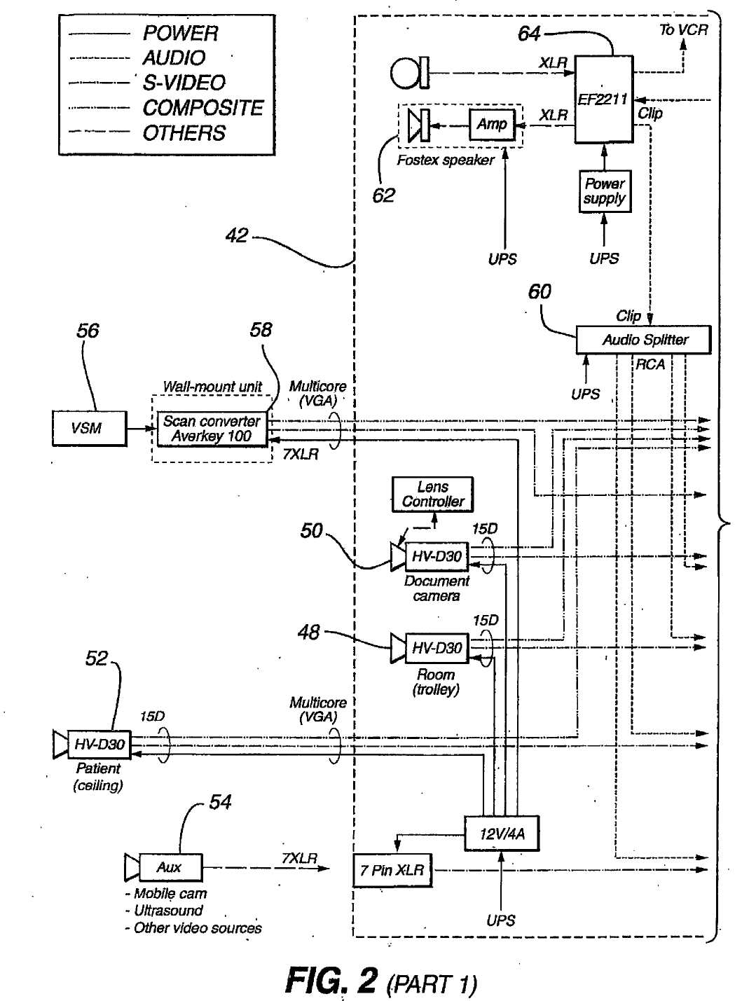

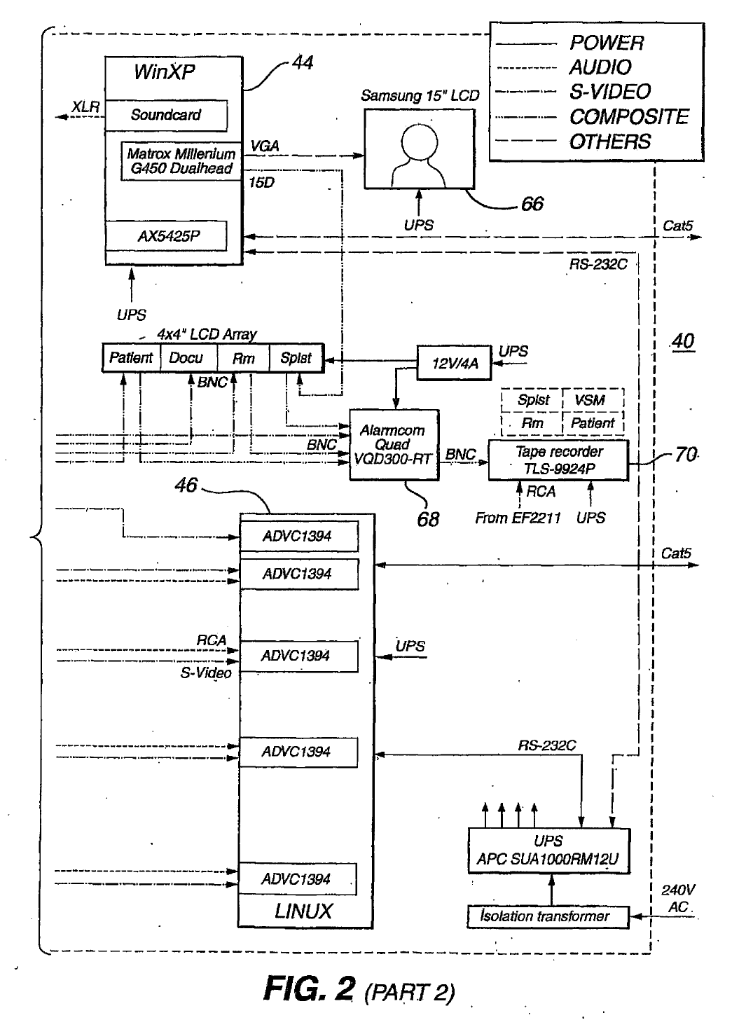

The system 10 illustrated in FIG. 1 is intended for use by a specialist doctor who may be located at a major hospital. The hardware of FIG. 2 is intended for use by nurses or doctors in a smaller hospital that is provided at a location remote from the specialist hospital and does not have specialist doctors. As will be described, the system allows the specialist to make a diagnosis of a patient located at the smaller hospital. The hardware of FIG. 1 will hereinafter be referred to as the specialist unit 10, the hardware of FIG. 2 will be hereinafter referred to as the remote unit 40.

Referring to FIG. 1 a system 10 for controlling transmission and display of video signals is shown in the form of specialist unit 12. Specialist unit 12 includes a desktop unit 14 which includes interface hardware provided on a desk for use by a medical specialist. The interface hardware includes mouse 22, video camera 24, LCD display 26, high quality colour CRT displays 28 & 30, microphone 32 and speaker 34. In use a graphical user interface 35 is presented to the specialist by way of LCD screen 26.

Specialist unit further includes cabinet unit 16 which is typically mounted underneath the desk of the specialist and which includes two IBM compatible personal computers (“PC's”) being master PC 18 and a slave PC 20.

Specialist unit 12 includes receiving means for receiving one or more video signals in the form of Cat5 network cables 36 & 37 which connect to Ethernet connections provided in master PC 18 and slave PC 20 respectively. These connections receive video signals in the form of data packets from a remote location as will later be de bed. Master PC 18 provides overall control of system 10. It displays graphical user interface 35 on LCD screen 26 and includes selection means in tee form of mouse 22 which can be used to interact with graphical user interface 35. Slave 20 includes video hardware 38 which drives monitors 28 & 30. Both of master 18 and slave 20 receive a video signal from camera 24 by way of video encoding cards 41 and 39. In use slave 20 operates under the control of master 18 as will later be described.

Referring to FIG. 2 a remote unit 40 which includes various video sources is shown and includes trolley unit 42 upon which the majority of the required hardware is mounted. The trolley is provided with wheels which allows the trolley 42 to be moved about at the remote location. Similarly to the specialist unit, remote unit 40 includes a master PC 44 and a slave PC 46.

Remote unit 40 operates to collect and transmit video signals under the control of specialist unit 12. Remote unit 40 includes various video sources as follows:
1) Room camera 48 is mounted to the trolley and normally points towards a patient lying in a hospital bed.
2) Document camera 50 is mounted on the trolley pointing down to a work surface being the top surface of a light box. Document camera 50 is used to view documents or X-rays on the work surface.
3) Ceiling camera 52 is mounted on the ceiling above the bed of a patient and provides a general overview of the room.

4) Auxiliary camera 54 may be connected to trolley unit 42 by way of a long lead and can be moved about the room to obtain, for example, a close up view of a wound or the like.

5) The patient has a vital signs monitor 56 that usually displays vital signs information on a small screen next to the patient. The video output from the vital sips monitor 56 is passed to trolley unit 42 via scan converter 58.

The video signals are encoded using the industry standard Digital Video (DV) codec. A packetising engine is used to convert the encoded signals into packets for transmission over a network.

Audio signals relating to the various video signals are combined at audio splitter 60. Sound may be output by trolley unit 42 by way of speaker 62. Speaker is driven by EF2211 Acoustic Echo/Noise canceller 64.

Trolley unit 42 further includes LCD monitor 66 which displays the output of video camera 24 (see FIG. 1) which is normally an image of the specialist sitting at specialist unit 12. LCD screen 66 is mounted on the trolley facing the patient so that the patient can see the specialist.

A quad view of the outputs of all four cameras patient 52, document 50, room 48, and specialist 24 is formed by quad 68 and recorded on time lapse video recorder 70 for audit purposes.

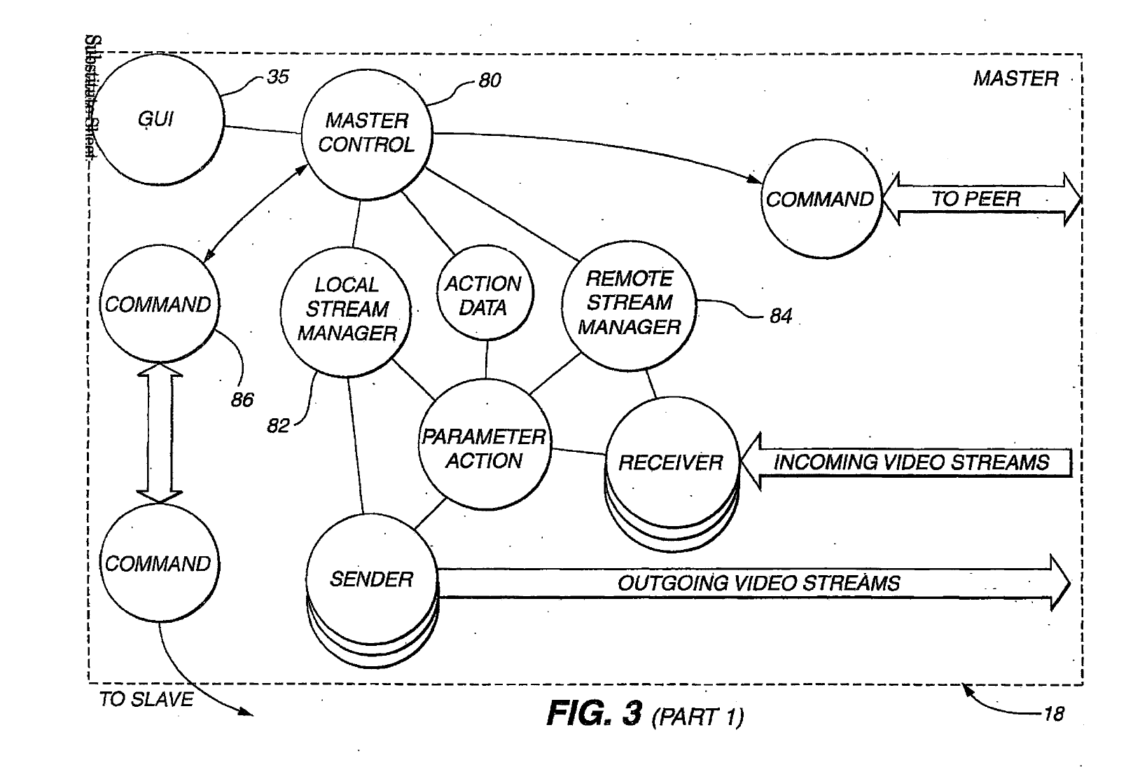

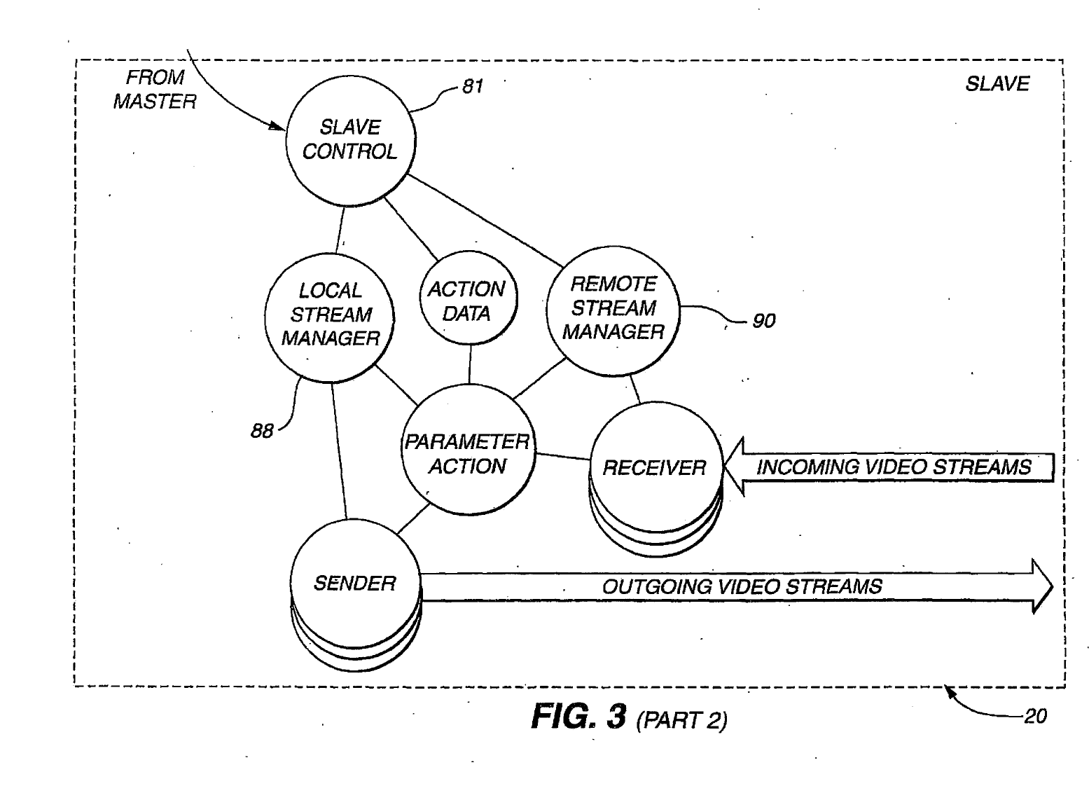

Referring to FIG. 3, the software modules running on both of specialist unit 10 and remote unit 40 will now be described.

The MasterControl 80 accepts commands from the GUI 35 and uses the communications channels to pass requests to the remote end 40 or to the Slave 20 as appropriate. MasterControl 80 also actions changes to the video streams being displayed locally on master PC 18. At start-up, it is responsible for reading and interpreting the configuration.ini file and for passing the appropriate sections to the Slave 20.

The Control class contains pointers to instances of three man classes: the Local Stream Manager 82, the Remote Stream Manager 84 and the Command class 86, which is responsible for handling signalling messages between MasterControl 80 peers and between the Master Control 80 and Slave Control 81 objects.

SlaveControl 81 provides a subset of the Master Control 80 functionality. It is effectively a proxy for the MasterControl 80 object, performing the functions of interfacing with the Local 88 and Remote Stream Managers 90 on the Slave 20. The Local Stream Manager 82, 88 looks after video sums emanating from cameras connected to the local PC 18 & 20. It initialises the streams based on the local configuration defaults and then modifies their parameters based on commands from the Control object. These commands are initiated either by the GUI software 35, or from the remote end. They include changing the frame rate, and modifying the destination IP address and/or UDP port of the steam.

Commands directed at cameras connected to the Slave 20 are identified by the MasterControl 80 object and forwarded to the SlaveControl 81 object for processing. The SlaveControl 81 object then asks its local Stream Manager 88 to perform the requested action.

The Remote Steam Manager 84, 90 looks after video steams emanating from cameras connect to the remote PCs 40 and displayed on local screens. It initialises the local screens based on the local configuration and associates them with camera information passed from the remote end during session establishment Once the screens have been initialised, the Remote Stream Manager 84, 90 performs no further actions on the streams. If the user requests that a particular remote camera's output be displayed on a given local stream, the MasterControl 80 object retrieves the required action information from the Remote Stream Manager 84, 90 and passes a request to its remote peer 40 so that it can be actioned by that Master or Slave Control's Local Stream Manager.

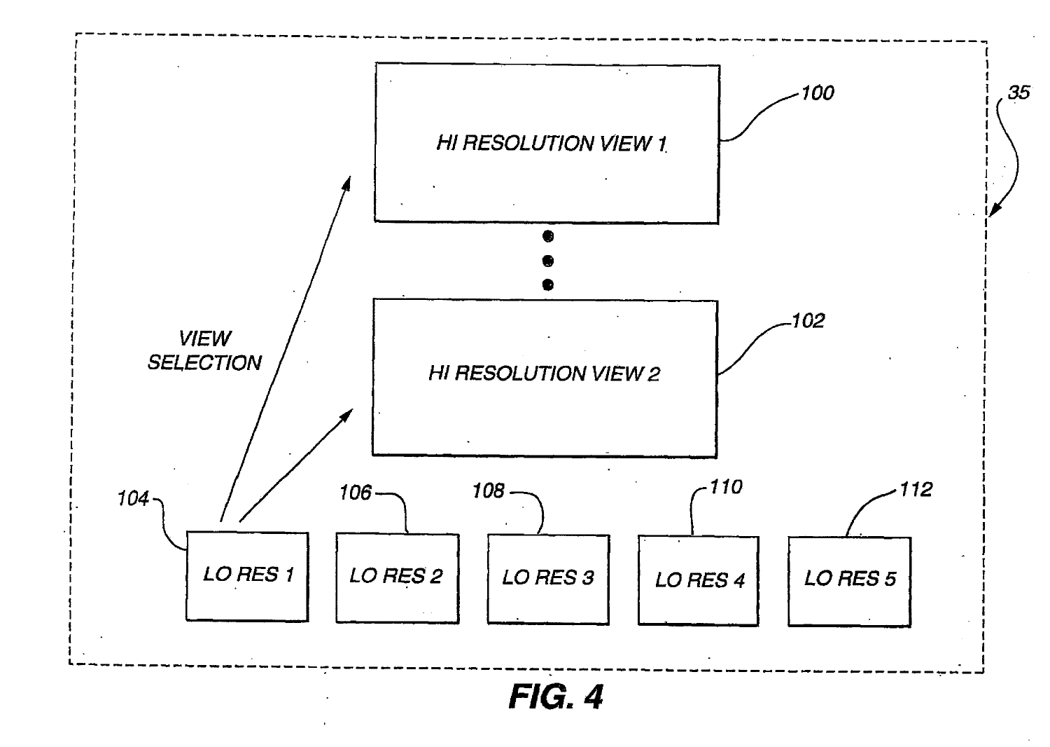

The user controls the display of remote camera's output by way of user interface 35. Referring to FIG. 4, interface 35 includes two screen areas “High resolution view 1” 100 and “high resolution view 2” 102. Along the bottom of the screen are five screen areas “Low res 1” 104, “Low res 2” 106, “Low res 3” 108, “Low res 4” 110 & “Low res 5” 112.

In use, the remote unit 42 transmits low resolution video signals derived from the video sources 48, 50, 52, 54 & 56 at the remote end. These are displayed in the screen areas 104, 106, 108, 110 & 112 respectively. If the user at specialist unit 10 wishes to view a particular video signal in high resolution then they select the low resolution screen area and drag it to either of screen areas 100 or 102. The screen areas 100 & 102 correspond to the high quality CRT displays 28 & 30 respectively. Thus, if the user selects screen area “Low res 1” 104 which displays a low resolution signal from room camera 48, and drags it to screen area “High resolution view 1” 100 thou the Master 18 sends a command via Master Command 80 to cause remote unit 40 to transmit a high resolution video stream derived from Room camera 48. In turn, Local Stream Manager 82, 88 receives the high quality steam and causes it to be displayed on high quality CRT monitor 28 and also causes it to be displayed on the GUI in the screen area “High resolution view 1”.

If the user wishes to view a different video source in high resolution then they drag and drop the appropriate “Low res” screen item onto either of screen areas “High resolution 1” or “High resolution 2”. If a high resolution stream was already being displayed in the particular high resolution screen area to which a “Low res” screen item is dropped, then the system operates to stop transmission of that high resolution strewn at the time that the new high resolution stream is activated.

The system allows the specialist to view the patient, and other information related to the patient, in a high resolution view thus allowing for accurate diagnosis that would not be reliable with low quality video. At the same time, by transmitting high quality video only when selected, bandwidth usage over the connection between the remote and near end points of the system is minimised.

The system may continue transmission of previously selected high resolution streams up until the bandwidth available over the connection between Systems is utilised.

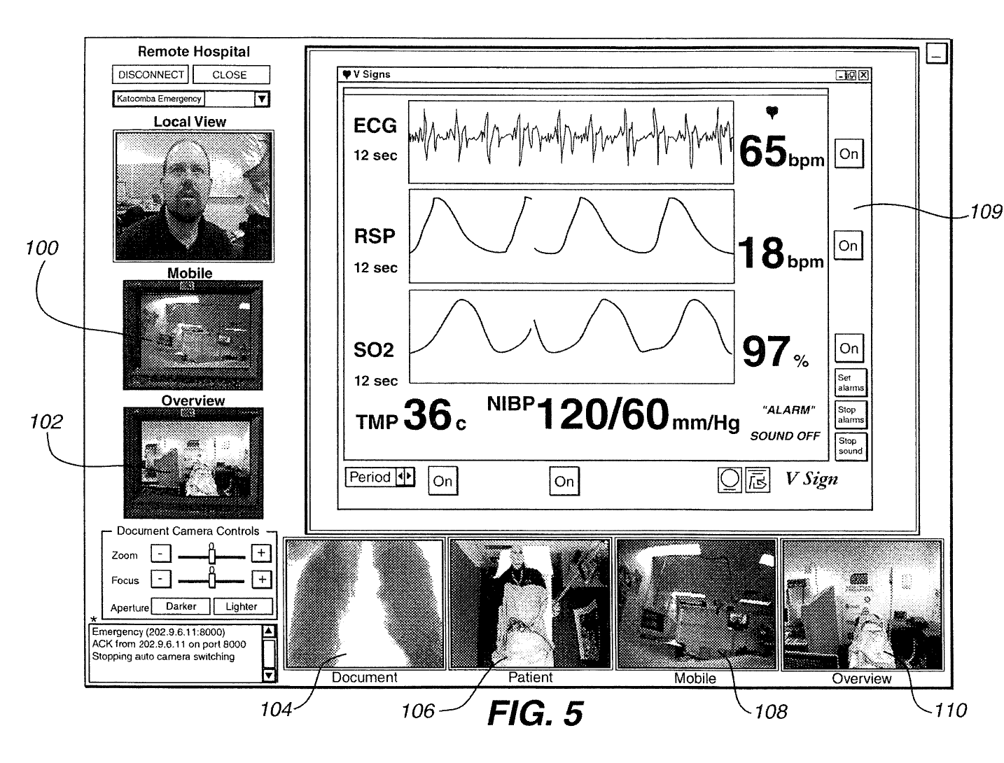

Referring to FIG. 5, an alternative arrangement of user interface is shown as it might appear in use. Common reference numerals are used to indicate corresponding features between FIGS. 4 and 5. Low res screen areas 104, 106, 108, 110 display low resolution video signals. Any of these can be dragged to “high resolution” areas 100, 102 to cause a high resolution video signal to be transmitted and displayed on one of two high quality CRT monitors (not shown). In this embodiment, the output from the vital signs monitor 56 is permanently displayed in a large screen area 109.

By use of the above system, the specialist can at all times see the output of all five video sources provided at the remote end. In the event that the specialist requires a more detailed view, they can elect to cause transmission of a higher resolution video stream that corresponds to the low resolution stream. This arrangement goes to minimising the consumption of available network bandwidth between the specialist unit 10 and the remote unit 40 as a high resolution stream is only transmitted when the specialist wishes to view it. If high resolution signals were transmitted constantly from all five video sources at the remote end then this would means consumption of considerable network bandwidth which could cause network congestion and high running costs if network usage is paid for according to the amount of data transmitted.

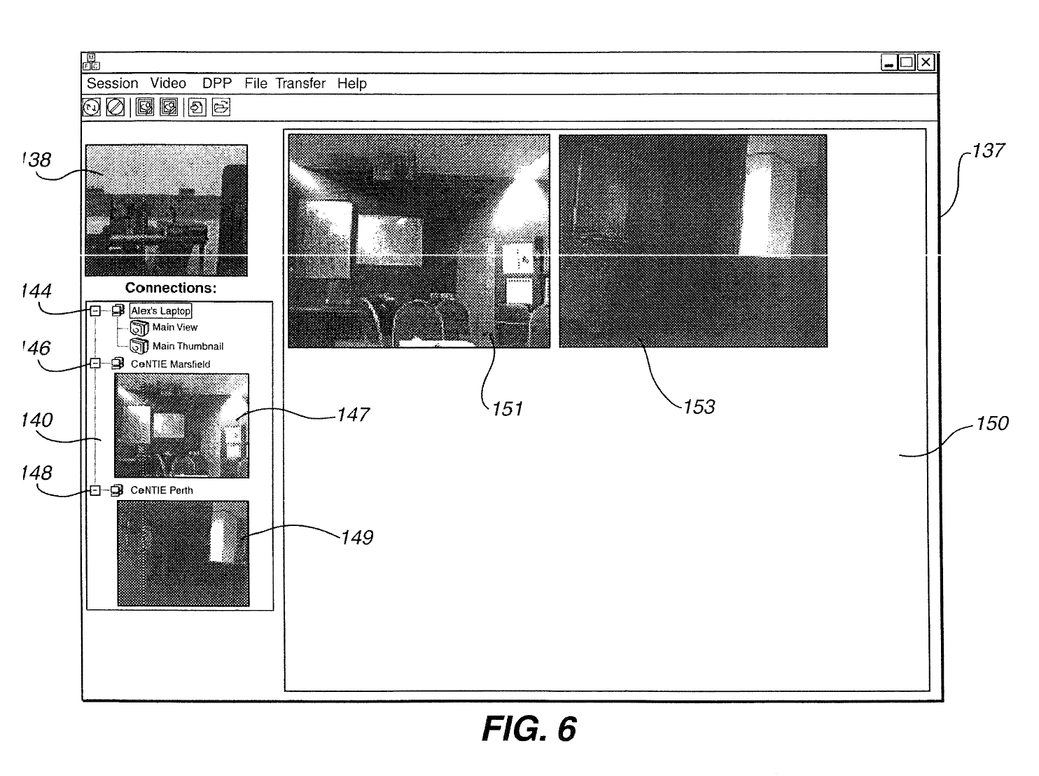

In the above described embodiment the specialist unit could be used to control the transmission of video signals from the remote location. The remote location received and displayed a video image of the specialist and no control over this was provided. In an alternative arrangement, two or more of the systems of the type used by the specialist can be connected. In this arrangement, a user at any location can control transmission of video signals from the other locations. FIG. 6 illustrates an alternative user interface that can be used in such an arrangement.

Referring to FIG. 6, the user interface is shown as it might appear during a videoconferencing session. The interface includes a screen area 138 which displays the output of the main criteria used at the local end. This allows the local user to see what signal others can receive from his end. Interface 137 further includes a screen area 140 “connections” which displays the name of the local end 144, in this case “Alex's laptop” and also displays the names of other available locations 146, 148 in this case “CeNTIE Marsfield” and “CeNTIE Perth”. Below the name of each remote location is a low resolution screen area 147, 149 which displays a low resolution video stream transmitted by each of the remote locations. Should the local user wish to view one of the low resolution video steams in more detail then they drag and drop the image 147 or 149 into screen area 150. This causes a command to be sent to the appropriate remote end to cause it to send a high resolution video signal to the local end. The local end displays the received high resolution vide stream in screen area 150. In this case, high resolution streams corresponding to the streams displayed 147, 149 are displayed numbered 151 and 153.

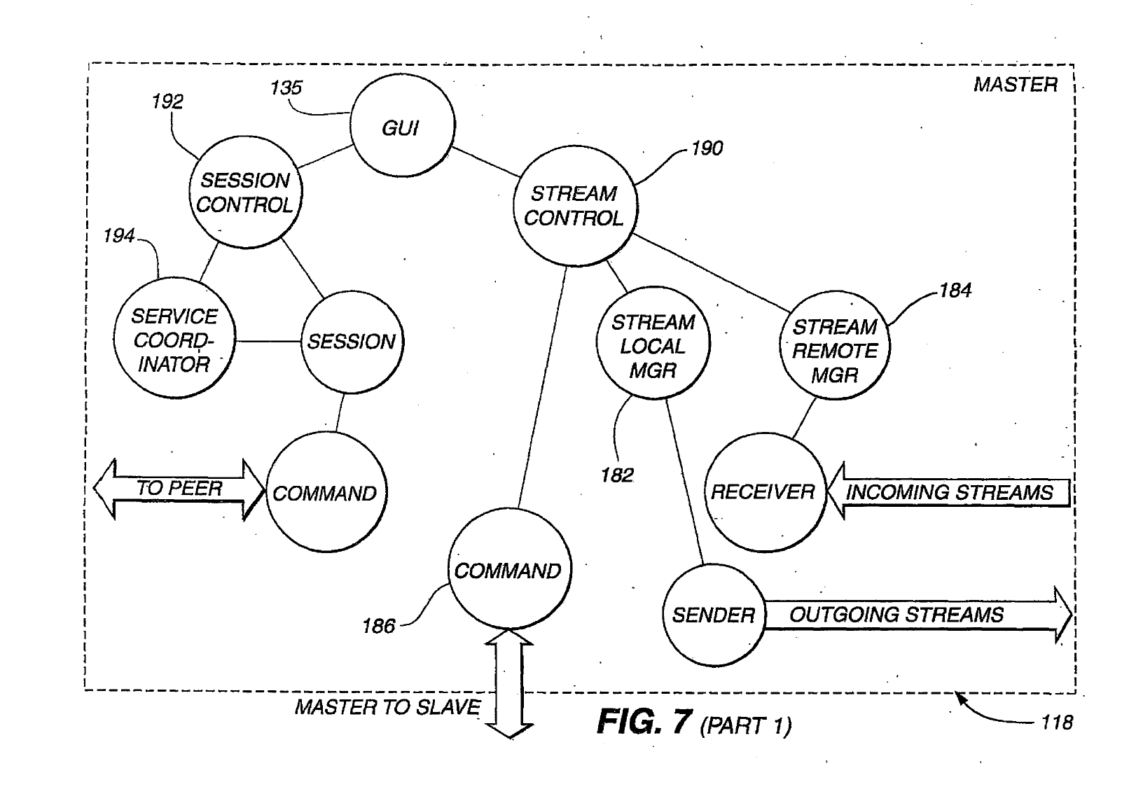

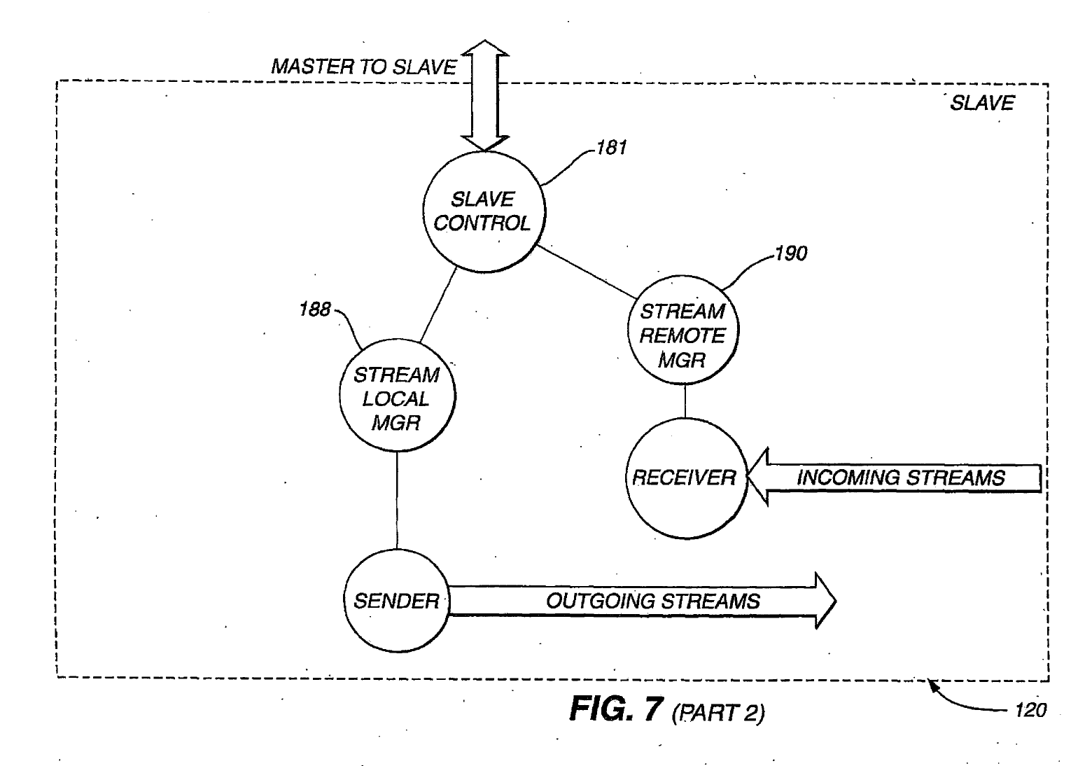

Referring to FIG. 7, the software used in the system of FIG. 6 is shown in schematic form. The software differs mainly to the arrangement of FIG. 3 in the addition of StreamControl 190 and Session control 192.

StreamControl 190 is responsible for initialising and controlling the video services provided by a library “StreamLib”. It makes use of the local configuration to identify the available resources—essentially local cameras and screens—and the ServiceCoordinator 194 to identify remote cameras.

Once the local camera (send) streams and screen (receive) streams have been initialised, StreamControl 190 responds to four main control inputs: the user, via the GUI 135; the Service Coordinator 194 as a result of received Content Advertisement messages; its peer Stream control entities via Video Info messages; and the Session Layer.

Stream Control's 190 actions on receiving most inputs are to process the input (adding to, deleting from, or modifying its list of known video sources), then check to see if the current assignment of streams to screen should change and to make the appropriate reassignments if required.

The checking and reassigning are performed in an operation SetScreens. It loops through the screens, from highest priority (Screen 0) to lowest, attempting in each case to find the highest priority remote camera which is intended to be visible and is not already assigned to a higher priority screen. The loop needs to avoid potentially high priority content such as local screens which are not being shown because the “ShowLocalVideo” option is not set, and remote streams which the user has not joined. As a result, the stream at priority 1 will not always be shown on Screen1, for example.

The loop is also executed for low quality video signal distribution.

The exception to the use of SetScreens is when the input is from the Session Layer indicating that a new session has been started or an existing session closed. In this case, Stream Control 190 will either start or stop streams in bulk.

### Input Processing—GUI Input

The primary GUI inputs are joining/leaving content and changing video steam priorities. When the user decides to join content which is currently unviewed, Stream Control 190 notes the change in subscribed content and calls SetScreens. The change in content to which the endpoint is subscribed is relayed through the ServiceCoordinator 194. Similar action is taken when priorities are changed.

### Input Processing—Service Coordinator Input

Stream Control 190 registers with the Service Coordinator 194 at start-up, requesting that it be informed of any changes in content which bears the Type value 1—i.e. video content. Content Advertisement messages containing changes in video content are forwarded to Stream Control 194 which checks to see if any new remote sources have appeared or known sources have disappeared. If changes have occurred, it then fixes the camera priorities, if required, to make sure they are contiguous and calls SetScreens.

### Input Processing—Peer Input

Peer Stream Control input is received via a VIDEO_INFO message which contain up to three lists. At a minimum, it contains the RxStreams list, a list of UIDs, which indicates which content the endpoint is currently viewing. Stream Control 190 uses this as a keep-alive for its local streams so that it can turn off unviewed streams if so configured.

The list may also contain a list of slave addresses owned by the remote peer. These are necessary in the unicast case to identify streams which are destined for the slaves of the remote endpoint. The RxStreams list is insufficient in this case, as more than one endpoint may be subscribed to the same content, but only one will be receiving it.

Finally, the video info message may contain stream priority information, another list of UIDs. If an endpoint is configured as the session video controller, it will include this list in its video info messages. Only endpoints which are configured to accept video control will take any notice of this information.

The above described embodiment related to use of the system in a medical application by a specialist to diagnose a patient at a remote location. Similarly, the system finds application in any environment where it is desirable to select the output of one or more remote video sources.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. A system for controlling transmission and display of video signals derived from video sources including:
receiving means for receiving two or more first video signals each derived from video sources;
a graphical user interface;
selection means allowing a user to select one of the first video signals on the graphical user interface;
when a user selects a first video signal the system is arranged to operate to cause transmission of a second video signal corresponding to the selected first video signal.

2. A system according to claim 1 wherein the second video signal is transmitted at a higher data rate than the selected first video signal.

3. A system according to claim 1 wherein the second video signal is transmitted at a higher resolution or frame rate than the selected first video signal.

4. A system according to claim 1 wherein the system is arranged to cease transmission of another video signal upon transmission of the second video signal.

5. A system according to claim 1 wherein the system is arranged to cease transmission of video signals to keep bandwidth usage below the available bandwidth.

6. A system according to claim 1 wherein the user interface allows a user to select a display destination for the second video signal.

7. A system according to claim 6 wherein the display destination is selected by dragging an item on the interface to a particular area of the interface.

8. A system according to claim 1 wherein the system is arranged to display the second video signal in a screen area of the graphical user interface.

9. A system according to claim 1 wherein the system is arranged to display the second video signal on a monitor separate from the graphical user interface.

10. A method of controlling transmission and display of video signals derived from video sources including the steps of:
receiving one or more first video signals each derived from video sources;
selecting one of the first video signals by way of a graphical user interface;
causing transmission of a second video signal corresponding to the selected first video signal.

11. A method according to claim 10 wherein the second video signal is transmitted at a higher data rate than the selected first video signal.

12. A method according to claim 10 wherein the second video signal is transmitted at a higher resolution or frame rate than the selected first video signal.

13. A method according to claim 10 wherein transmission of another video signal is ceased upon transmission of the second video signal.

14. A method according to claim 10 wherein transmission of other video signals is ceased to keep bandwidth usage below the available bandwidth.

15. A method according to claim 10 wherein the user interface allows a user to select a display destination for the second video signal.

16. A method according to claim 15 wherein the display destination is selected by dragging an item on the interface to a particular area of the interface.

17. A method according to claim 10 wherein the second video signal is displayed in a screen area of the graphical user interface.

18. A method according to claim 10 wherein the second video signal is displayed on a monitor separate from the graphical user interface.

19. A method according to claim 10 wherein the first and second video signals are transmitted from a remote location.
